(19) United States
(12) Patent Application Publication
(10) Pub. No.: US 2006/0280972 A1
(43) Pub. Date: Dec. 14, 2006

(54) Magnetic recording medium and magnetic storage

(75) Inventor: Takashi Gouke, Higashine (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/231,469

(22) Filed: Sep. 21, 2005

(30) Foreign Application Priority Data
Jun. 8, 2005 (JP) 2005-168899

(51) Int. Cl. G11B 5/66

(52) U.S. Cl. 428/829; 428/828.1; 428/832.2

(57) ABSTRACT

A magnetic recording medium includes: a substrate; a underlayer, produced on the substrate, comprising Cr or Cr alloy: a first magnetic layer, produced on the underlayer, comprising CoCr or CoCr alloy; an RuB alloy layer produced on the first magnetic layer; and a second magnetic layer, produced on the RuB alloy layer, comprising CoCrPt or CoCrPt alloy, and coupled with the first magnetic layer in an antiferromagnetic exchange coupling manner, wherein: the RuB alloy layer comprises RuB having an hcp structure or RuB alloy having Rub as a chief ingredient, and also, epitaxially grows on a surface of the first magnetic layer; and the second magnetic layer epitaxially grows on a surface of the RuB alloy layer.

### BACKGROUND OF THE INVENTION

1. Field of the Invention

The present invention relates to a magnetic recording medium and a magnetic storage provided therewith, and, in particular, to a magnetic recording medium having a thin-film magnetic layer and a magnetic storage provided therewith.

2. Description of the Related Art

Recently, a magnetic storage, for example, a magnetic disk device is applied for a wide variety of usage as a storage device for a digitized motion picture or music. For the magnetic disk device, a demand has been increasing sharply for a usage as a home motion-picture recording storage device or a potable music player. Since a motion picture or music has a large information amount, a magnetic disk device has been requested to have an increased storage capacity. For this purpose, technical development for further increasing a recording density in a magnetic recording medium and a magnetic head is required.

As one method for increasing a recording density of a magnetic recording medium, a method can be cited for reducing medium noise of the magnetic recording medium and improving a signal-to-medium-noise ratio (S/Nm). In order to reduce medium noise, various studies have been proceeded with for reducing a grain diameter of crystal grains included in a recording layer of the magnetic recording medium, so as to achieve so-called crystal grain miniaturization.

A magnetization transition region is produced between adjacent magnetization regions produced in a recording layer as a result of a recording operation of a recording head being carried out. The magnetization transition region is changed from a zigzag shape to a straight line shape throughout a width of the magnetization region as the crystal grain miniaturization progresses. As a result, a magnetization transition region is produced along with inverting operation of a recording magnetic field of the recording head and medium noise is reduced. However, the crystal grain miniaturization of a recording layer has been about to reach a limit.

Further, another method of increasing a recording density is to improve a signal-to-noise ratio of a magnetic storage in total. A total S/N is determined from not only a signal-to-medium-noise of a magnetic recording medium but also a signal-to-noise ratio of a reproduction device of a magnetic head, performance of a signal processing circuit and so forth. The total S/N can be improved as a result of these respective factors being improved.

Japanese Laid-open Patent Applications Nos. 2001-056924, 2001-148110, 2003-022511 and 2004-515028 disclose related arts.

### SUMMARY OF THE INVENTION

In order to improve the total S/N, reduction in a film thickness of a recording layer of a magnetic recording medium is required. By reducing a film thickness of a recording layer, reproduction resolution improves, and thus, performance advantageous for increasing a recording density is obtained.

However, when a film thickness of a recording layer is reduced, a coercive force sequareness ratio of the magnetic recording medium tends to fall. When the coercive force sequareness ratio falls, a signal-to-medium-noise ratio lowers according to a simulation carried out by the inventor of the present invention. Thereby, the total S/N ratio falls accordingly, and thereby, increase in a recording density is adversely affected.

The present invention has been devised in consideration of the above-mentioned problem, and an object of the present invention is to provide a magnetic recording medium and a magnetic storage by which increase in a recording density from a reduction of a recording layer can be effectively achieved.

From one aspect of the present invention, a magnetic recording medium is provided including a substrate; an underlayer, produced on the substrate, made of Cr or Cr alloy: a first magnetic layer, produced on the underlayer, made of CoCr or CoCr alloy; an RuB alloy layer produced on the first magnetic layer; and a second magnetic layer, produced on the RuB alloy layer, made of CoCrPt or CoCrPt alloy, and coupled with the first magnetic layer in an antiferromagnetic exchange coupling manner, wherein: the RuB alloy layer is made of RuB having an hcp structure or RuB alloy having the Rub as a chief ingredient, and also, epitaxially grows on a surface of the first magnetic layer; and the second magnetic layer epitaxially grows on a surface of the RuB alloy layer.

According to the present invention, the RuB alloy layer is provided between the first magnetic layer and the second magnetic layer. The RuB alloy layer grows epitaxially on the first magnetic layer and the second magnetic layer epitaxially grows on the RuB alloy layer. Further, a grain boundary segregation structure is produced in the RuB alloy layer from B (boron) in the film, a grain boundary segregation structure of the first magnetic layer is inherited thereby, and also, production of a grain boundary segregation structure is accelerated. Thereby, a crystallinity and crystal orientation improve in an initially growing region of the second magnetic layer. As a result, degradation in magnetostatic characteristics otherwise occurring due to reduction of a film thickness of the second magnetic layer can be inhibited, and degradation in signal-to-medium-noise ratio can be inhibited. Thereby, it is expected that a total S/N ratio of a magnetic storage can be improved. Epitaxial growth means growth in which at least a crystal plane in a thickness direction is oriented due to an influence of a surface of a lower layer.

From another aspect of the present invention, a magnetic storage is provided including the above-mentioned magnetic recording medium and a recording/reproduction unit having a recording device and a magneto-resistance effect type reproduction device.

According to the present invention, in the magnetic recording medium, degradation in the coercive force sequareness ratio due to reduction of a film thickness of a most-surface-side magnetic layer, for example, the second magnetic layer is inhibited, and degradation in S/Nm is inhibited. And also, reproduction resolution improves. Thereby, a total S/N of the magnetic storage improves, and thus, a recording density can be improved. Further, since degradation in characteristics of resistance to thermal fluctuation otherwise occurring due to reduction in film thickness of the most-surface-side magnetic layer is inhibited, increase in a recording density can be achieved in the magnetic storage.

According to the present invention, a magnetic recording medium and a magnetic storage by which increase in a recording density from a reduction in a film thickness of a recording layer can be effectively achieved can be provided.

### BRIEF DESCRIPTION OF THE DRAWINGS

Other objects and further features of the present invention will become more apparent from the following detailed description when read in conjunction with the accompanying drawings:

FIG. 1 shows a typical sectional view of a magnetic recording medium in the related art;

FIG. 2 shows a characteristic diagram with respect to a second magnetic layer thickness of a prototype example of the magnetic recording medium in the related art;

FIG. 3 shows a typical sectional view of a magnetic recording medium for illustrating a principle of the present invention;

FIG. 4 shows a plan micrograph of a RuB film;

FIG. 5 shows a sectional view of a magnetic recording medium in a first example according to a first carrying-out mode of the present invention;

FIG. 6 shows a sectional view of a magnetic recording medium in a second example according to the first carrying-out mode of the present invention;

FIG. 7 shows a sectional view of a magnetic recording medium in a third example according to the first carrying-out mode of the present invention;

FIGS. 8 and 9 show magnetostatic characteristics of magnetic disks in an embodiment 1 and a comparison example 1;

FIG. 10 shows resolution characteristics of the magnetic disks in the embodiment 1 and the comparison example 1;

FIG. 11 shows overwrite characteristics of the magnetic disks in the embodiment 1 and the comparison example 1;

FIG. 12 shows S/Nm of the magnetic disks in the embodiment 1 and the comparison example 1;

FIGS. 13, 14 and 15 show magnetostatic characteristics of magnetic disks in an embodiment 2 and a comparison example 2;

FIG. 16 shows overwrite characteristics of the magnetic disks in the embodiment 2 and the comparison example 2;

FIG. 17 shown S/Nm of the magnetic disks in the embodiment 2 and the comparison example 2;

FIG. 18 shows output change ratio of the magnetic disks in the embodiment 2 and the comparison example 2; and

FIG. 19 shows relevant parts of a magnetic storage according to a second carrying-out mode of the present invention.

### DETAILED DESCRIPTION OF THE PREFERRED EMBODIMENTS

The inventor of the present invention studied for a cause of a reduction in coercive force sequareness ratio occurring due to a reduction of a thickness of a recording layer. The coercive force sequareness ratio means a slope of a magnetization curve around a magnetic field equivalent to coercive force in a magnetization curve of a magnetic recording medium. As a cause of degradation in coercive force sequareness ratio, degradation of crystallinity or crystal orientation of particular crystal grains included in the recording layer, or increase in crystal grains having very small grain diameters was inferred.

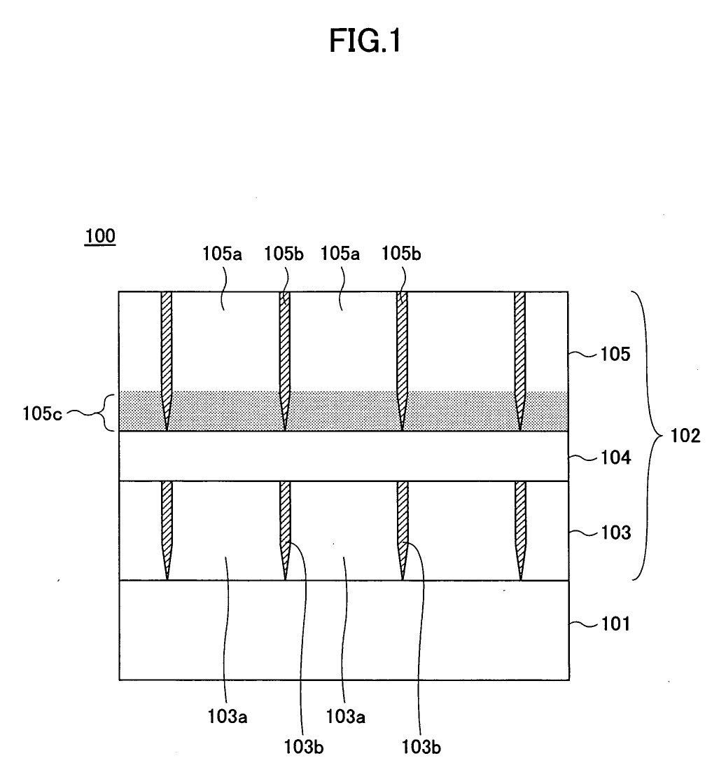

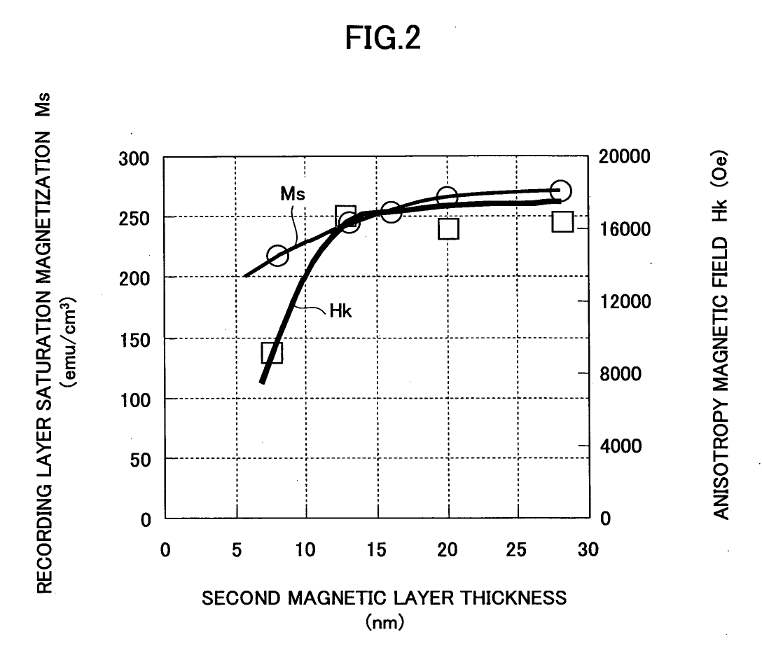

FIG. 1 shows a diagrammatic sectional view of a magnetic recording medium in the related art, and FIG. 2 shows characteristic diagram of a prototype example of a magnetic recording medium in the related art with respect to a second magnetic layer thickness. FIG. 2 shows relationship between recording layer saturation magnetization and the second magnetic layer thickness and relationship between anisotropy magnetic field and the second magnetic layer thickness, at a temperature 0 K. The recording layer saturation magnetization at a temperature 0 K was measured as a result of, with the use of a superconducting quantum interference device (SQUID) magnetometer, a range between 5 K and 300 K being measured, and then, saturation magnetization at 0 K being obtained from the measured data from the following calculation: Saturation magnetization M0 at 0 K was obtained from measured saturation magnetization M(T) assuming that (M0−M(T))/MO is in proportion to T^{3/2} where M(T) denotes saturation magnetization for the absolute temperature T (K). Further, the anisotropy magnetic field Hk was obtained as a result of so-called dynamic coercive force Hc′ being measured, and then, the following relational expression (1) for dynamic coercive force Hc′ and anisotropy magnetic field Hk by Bertram et al. (H. N. Bertram, H, J, Richter, Arrhenius-Neel: J. Appl. Phys., vol. 85, No. 8, pp. 4991 (1999)) being applied.
Hc′=0.474Hk{1−1.55[(k_{B}T/KuV)×ln(fot/ln2)/2]}^{2/3} (1)

There, T denotes an absolute temperature; fo denotes an attempt frequency; k_{B} denotes a Bolzmann constant; Ku denotes an anisotropy constant; V denotes a volume of a crystal grain; and t denotes a magnetic field switching time.

With reference to FIG. 1, the magnetic recoding medium 100 in the related art includes an underlayer 101 made of a Cr film and a recording layer 102 produced on the underlayer 101. The recording layer 102 has a structure in which a first magnetic layer 103 made of a CoCr film, a Ru film 104 and a second magnetic layer 105 made of a CoCrPtB film are laminated.

With reference to FIG. 2 as well as FIG. 1, saturation magnetization Ms of the recording layer 102 at a temperature 0 K falls as a thickness of the second magnetic layer 150 is reduced. Saturation magnetization Ms of the recording layer 102 was obtained from dividing saturation magnetization amount (unit: emu) of the recording layer 102 by a sum total of a volume of the first magnetic layer 103 and a volume of the second magnetic layer 105 (unit: cm³). The reduction in saturation magnetization Ms of the recording layer 102 results from a reduction in saturation magnetization in the second magnetic layer 105. Further, since saturation magnetization Ms of the recording layer 102 is saturation magnetization at a temperature 0 K, influence of thermal fluctuation does not exist. Accordingly, a cause of the reduction in saturation magnetization Ms of the second magnetic layer 105 along with a reduction in a thickness of the second magnetic layer 105 is inferred to be that a satisfactory grain boundary segregation structure is not produced at an initially growing region 105c of the second magnetic layer 105, i.e., a deposition beginning part around a surface of the Ru film 104. The grain boundary segregation structure includes crystal grains 105a and adjacent grain boundary parts 105b made of non-magnetic material separating the crystal gains 105a of the second magnetic layer 105 as shown in FIG. 1. A satisfactory grain boundary segregation structure means a state in which crystallinity of the crystal grains 105a is satisfactory and the crystal grains 105a are separated by the grain boundary parts 105b.

The state in which a satisfactory grain boundary segregation structure is not produced in the initially growing region 105c of the second magnetic layer 105 is also inferred sufficiently from a fact that an anisotropy magnetic field Hk of the recording layer 102 sharply falls when the second magnetic layer 105 is reduced in its thickness from around 10 nm. That is, it can be inferred that, crystal orientation is not satisfactory because crystallinity of the initially growing region 105c of the second magnetic layer 105 is not satisfactory, and thereby, an anisotropy magnetic field Hk of the second magnetic layer 105 falls.

This is presumably because a grain boundary segregation structure made of crystal grains 103a and grain boundary parts 103b of the first magnetic layer 103 cannot be inherited by the second magnetic layer 105 via the Ru film 104. That is, the Ru film 104 produced on the grain boundary segregation structure of the first magnetic layer 103 includes polycrystalline structure of the Ru film 104. Then, the second magnetic layer 105 includes a grain boundary segregation structure produced on a surface of the Ru film 104 in a self producing manner. Thereby, presumably, crystal orientation is not satisfactory, and crystallinity and crystal orientation of the crystal grains 105a degrade.

Therefore, as a result of a diligent study, the inventor of the present invention found out that a satisfactory grain boundary segregation structure could be obtained at a growth beginning by applying a RuB alloy layer instead of the Ru film 104 in the second magnetic layer 105. That is, the inventor found out that a grain boundary segregation structure was produced in the RuB alloy layer, and, by means of this grain boundary segregation structure, a satisfactory grain boundary segregation structure was produced in the initially growing region 105c of the second magnetic layer 105.

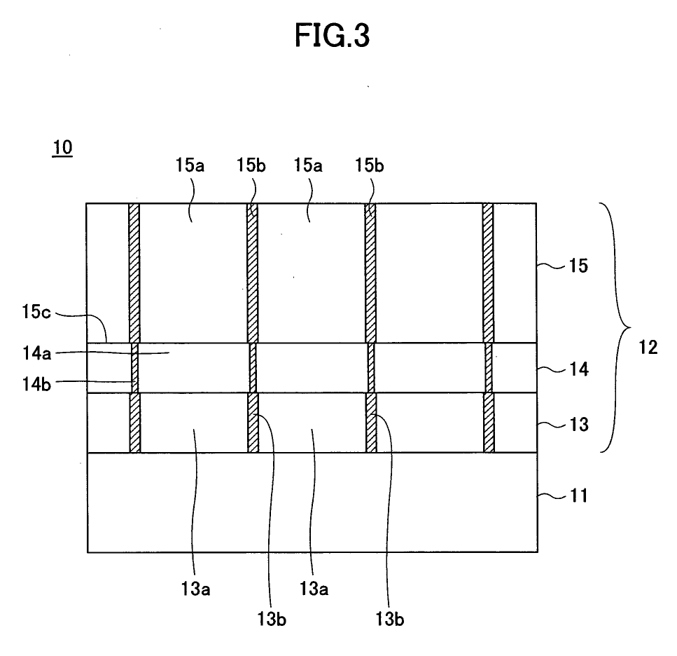

FIG. 3 diagrammatically shows a sectional view of a magnetic recording medium illustrating a concept of the present invention. As shown, the magnetic recording medium 10 includes an underlayer 11 made of Cr or Cr alloy; and a recording layer 12 produced on the underlayer 11. The recording layer 12 includes a first magnetic layer 13, a second magnetic layer 15 and a RuB alloy layer 14 therebetween. The RuB alloy layer 14 includes crystal grains 14a and grain boundary parts 14b produced between the adjacent crystal grains 14a. The crystal grains 14a are made of approximately single crystals, and the grain boundary part 14b is produced from segregation of B (Boron) included in the RuB alloy layer 14. That is, the RuB alloy layer has a grain boundary segregation structure.

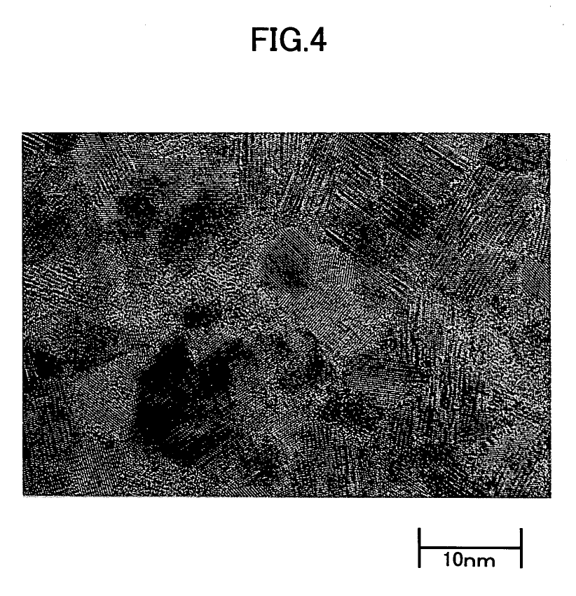

FIG. 4 shows a plan electron micrograph of a RuB film as one example of the RuB alloy layer. The RuB film has a composition of Ru₉₅B₅. It is noted that a composition is expressed by atomic %, and, the same manner is applied also in description of carrying-out modes. The RuB film is one produced on the first magnetic layer 13 of the magnetic recording medium 10 having approximately the same structure as that shown in FIG. 3. A thickness of the RuB film was 7 nm for the purpose of easy observation via an electron microscope.

As shown in FIG. 4, in the RuB film, crystal grains each having a grain diameter on the order of 4 through 10 nm with a regularly arranged crystal plane, and narrow gain boundary parts are seen. Thereby, it is seen that the RuB film has a crystal grain boundary structure.

Returning to FIG. 3, the grain boundary segregation structure is produced, in the RuB alloy layer 14 including the RuB film, including crystal grains 14a and grain boundary parts 14b for inheriting the grain boundary segregation structure made of the crystal grains 13a and the grain boundary parts 13b in the first magnetic layer 13. That is, on the crystal grains 13a of the first magnetic layer 13, the crystal grains 14a of the RuB alloy layer 14 grows epitaxially, and the grain boundary parts 14b of the RuB alloy layer 14 is produced on the grain boundary parts 13b of the first magnetic layer 13. Then, on the grain boundary segregation structure of the RuB alloy layer 14, the second magnetic layer 15 is produced. Thanks to the grain boundary segregation structure of the RuB alloy layer 14, a grain boundary segregation structure made of crystal grains 15a and grain boundary parts 15b is produced in the second magnetic layer 15. Inheriting a grain boundary segregation structure means that crystal grains of an upper layer epitaxially grow on crystal grains of a lower layer, and also, grain boundary parts of the upper layer are produced along with grain boundary parts of the lower layer. Thereby, in the second magnetic layer 15, an initially growing region at an interface 15c from the RuB alloy layer 14 has satisfactory crystallinity and crystal orientation in the crystal grains 15a, and thus, a reduction in coercive force sequareness ratio can be inhibited even when the second magnetic layer 15 is reduced in its thickness.

Below, modes for carrying out the present invention (simply referred to as carrying-out modes) are described with reference to figures.

A first carrying-out mode is described now.

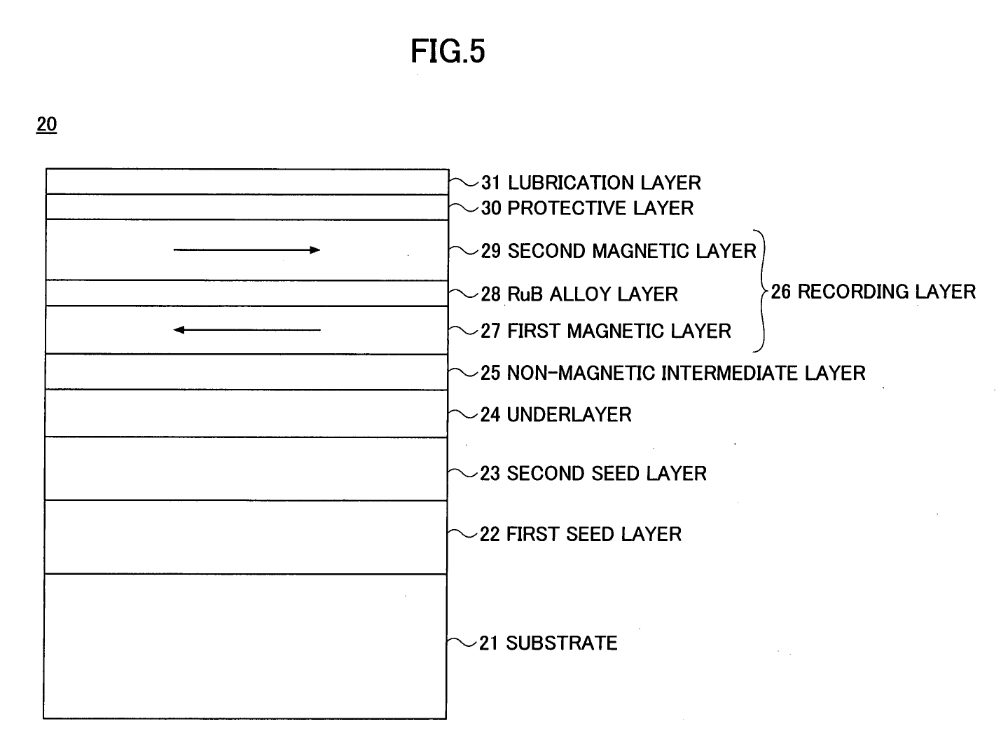

FIG. 5 shows a sectional view of a magnetic recording medium in a first example according to the first carrying-out mode of the present invention.

As shown, the magnetic recording medium 20 in the first example has a configuration in which a substrate 21, and thereon, a first seed layer 22, a second seed layer 23, an underlayer 24, a non-magnetic intermediate layer 25, a recording layer 26, a protective layer 30 and a lubrication layer 31 are laminated. The recording layer 26 has a configuration in which, from the side of the non-magnetic intermediate layer 25, a first magnetic layer 27, a RuB alloy layer 28 and a second magnetic layer 29 are laminated in the stated order.

To the substrate 21, a well-known material such as a glass substrate, a Ni plated aluminum alloy substrate, a silicon substrate, a plastic substrate, a ceramic substrate, a carbon substrate or such may be applied.

On the substrate 21, a so-called texture (not shown) made of many depressions and projections extending along a predetermined direction may be provided. The predetermined direction is preferably approximately the same as a recording direction in the magnetic recording medium 20. For example, when the magnetic recording medium 20 has a form of a disk, the predetermined direction is preferably approximately the same as a circumferential direction thereof. Thereby, a c-axis of an alloy film of CoCr, alloy of CoCrPt or such forming the first magnetic layer 27 or the second magnetic layer 29 can be oriented in the film surface and in the circumferential direction. Since the c-axis of the film of CoCr, CoCrPt or such is an easy axis of magnetization, coercive force increases, and as a result, magnetic characteristics advantageous as a magnetic recording medium having a high recording density can be obtained. The texture may be a so-called mechanical texture produced by means of a polishing/grinding method using slurry including abrasive. Further, the texture may be depressions and projections produced regularly as a result of an ion beam being applied in an oblique direction to the substrate surface. The texture may be produced not only on the surface of the substrate 21 but also, instead, on a surface of the first seed layer 22 or the second seed layer 23 described below.

The first seed layer 22 is made of amorphous non-magnetic metal material. As metal preferable to the first seed layer 22, CoW, CrTi, NiP, CoCrZr and metals having these as chief ingredients may be cited. Further, a thickness of the first seed layer 22 is preferably within a range between 5 and 30 nm. Since a surface of the first seed layer 22 is amorphous and crystallographically uniform, this does not exert an influence of crystallographic anisotropy on the second seed layer produced thereon. As a result, a crystal structure can be easily produced in the second seed layer 23 itself. Accordingly, crystallinity and crystal orientation in the second seed layer 23 improve. Thereby, crystallinity and crystal orientation in the recording layer 26 thereabove is improved via the underlayer 24 and so forth. Especially, since the RuB alloy layer 28 inherits crystallinity and crystal orientation of the first magnetic layer 27 to the second magnetic layer 29, crystallinity and crystal orientation in the second magnetic layer 29 improve.

When the second seed layer 23 is omitted, and the underlayer 24 is provided on the first seed layer 22, the same effect is given to the underlayer 24 from the first seed layer 22.

The second seed layer 23 is made of crystalline non-magnetic metal material having a B2 structure. For example, AlRu or NiAl is preferable. A thickness of the second seed layer 23 is preferably set within a range between 1 and 100 nm. The B2 structure is a metal rule phase in a type of CsCl (cesium chloride) having a bcc (body-centered cubic) structure as a basic structure. Further, since the underlayer 24 produced on the second seed layer 23 has a bcc structure, the second seed layer 23 and the underlayer 24 approximate one another in their crystal structures. Accordingly, crystal orientation in the underlayer 24 improves by the second seed layer 23.

The second seed layer 23 is polycrystal made of many crystal grains. The second seed layer 23 may be configured as a result of films each made of the above-mentioned material with a thin film (for example, 5 nm in thickness) being laminated for the purpose of inhibiting increase in a grain diameter of each crystal grain on a section parallel to a film surface of the second seed layer 23. Thereby, increase in th grain diameters of the crystal grains can be inhibited while crystallinity of the second seed layer itself is maintained. Thereby, increase in the grain diameters of the crystal grains of each of the first magnetic layer 27 and the second magnetic layer 29 can be inhibited via the underlayer 24 and so forth.

It is noted that any one of the first seed layer 22 and the second seed layer 23 may be omitted from the magnetic recording medium 20 although it is preferable to provide both.

For material of the underlayer 24, selection is made from Cr or Cr—X1 alloy having a bcc structure (X1 is at least any one of W, V, Mo and Mn). A thickness of the underlayer 24 is set within a range between 1 and 20 nm. The underlayer 24 may employ Cr—X1 alloy, and therewith can improve lattice matching with the non-magnetic intermediate layer 25 thereabove, and improve crystallinity of the first magnetic layer 27 and the second magnetic layer 29. Further, the underlayer 24 may employ Cr—X1 alloy, and therewith, even when the non-magnetic intermediate layer 25 thereabove is omitted, may improve crystal matching with the first magnetic layer 27 directly contacting it, and improve crystallinity of the first magnetic layer 27 and the second magnetic layer 29.

Further, the underlayer 24 may employ a plurality of layers each made of Cr—X1 alloy laminated therein. By applying the laminate, increase of crystal gains in their sizes in the underlayer 24 itself can be inhibited, and also, increase of crystal gains in their sizes in the first magnetic layer 27 and the second magnetic layer 29 can be inhibited.

The non-magnetic intermediate layer 25 is made of non-magnetic material of Co—X2, CoCr, CoCrB, CoCr—X2 or CoCrB—X2 having a hcp structure. There, X2 is at least any one selected from Ta, Mo, Mn, Re, Ru and Hf. A thickness of the non-magnetic intermediate layer 25 is set within a range between 0.5 and 5.0 nm (preferably, in a range between 0.5 and 3.0 nm).

The non-magnetic intermediate layer epitaxially grows on a surface of the underlayer 24, and a c-axis of the hcp structure is oriented in parallel to a (100) plane of Cr or Cr—X1 alloy of the underlayer 24. This c-axis orientation is inherited by the first magnetic layer 27, the RuB alloy layer 28 and the second magnetic layer 29 above the non-magnetic intermediate layer 25.

Further, especially, the non-magnetic intermediate layer 25 may be preferably made of CoCrB or CoCrB—X2. A grain boundary segregation structure is produced by CoCr, and further, B is included in the non-magnetic intermediate layer 25, whereby a grain diameter of crystal grains can be reduced.

Further, the non-magnetic intermediate layer 25 may be preferably made of CoCrB—X2. In CoCrB—X2, as a result of an additional element or alloy X2 being added to a crystal lattice made mainly of CoCr, distortion caused in a crystal structure of CoCr is inhibited, while Co concentration is reduced to provide non-magnetic property.

Further the non-magnetic intermediate layer 25 may be made of a plurality of layers each made of the above-mentioned material laminated therein. It is noted that, although the non-magnetic intermediate layer 25 should be preferably provided, it should not be necessarily provided.

The recording layer 26 is made of the first magnetic layer 27, the RuB alloy layer 27 and the second magnetic layer 29, and has an exchange coupling structure in which the first magnetic layer 27 and the second magnetic layer 29 are antiferromagnetically coupled in an exchange coupling manner. Magnetization oriented in a direction along a film surface of the first magnetic layer 27 and the second magnetic layer 29 is directed in mutually antiparallel directions in a state in which no external magnetic field is applied.

The first magnetic layer 27 is made of CoCr, CoCrB, CoCr—M1 alloy or CoCrB—M1 alloy, where M1 is at least any one selected from Pt, Ta, Ni, Cu, Ag, Fe, Nb, Au, Mn, Ir, Si and Pd). By employing the material, a grain boundary segregation structure made of crystal grains and grain boundary parts shown in FIG. 3 mentioned above is produced in the first magnetic layer 27. Cr segregates in the grain boundary parts, and a non-magnetic part is produced. The crystal grains are produced from CoCr or ferromagnetic material having CoCr as a chief ingredient. The crystal grains have crystal orientation such that a c-axis is directed in a direction along a film surface, from the crystal orientation of the non-magnetic intermediate layer 25.

The first magnetic layer 27 may be preferably made of CoCrB or CoCrB—M1 alloy in terms of accelerating grain boundary segregation in the RuB alloy layer 28. By thus applying the material including B in the first magnetic layer 27, B segregates in the grain boundary parts, and also, segregation of Cr is accelerated so that the grain boundary parts become thicker, whereby Co concentration in the crystal grains increases. As a result, a satisfactory grain boundary segregation structure is produced in which saturation magnetization of particular crystal grains increases, and the crystal grains are mutually sufficiently separated. Further, it is expected that, when the RuB alloy layer 28 material is deposited on a surface of the first magnetic layer 27, B is provided from the first magnetic layer 27 to the grain boundary parts of the RuB alloy layer 28, and production of the grain boundary parts in the RuB alloy layer 28 are accelerated.

Further, the first magnetic layer 27 is set within a range between 0.5 and 20 nm in its thickness. The thickness of the first magnetic layer 27 is, as will be described later, appropriately set from a relation between a product of a thickness of the first magnetic layer 27 and residual magnetization thereof and a product of a thickness of the second magnetic layer 27 and residual magnetization thereof.

Further, the first magnetic layer 27 may be preferably made of a plurality of layers laminated each made of the above-mentioned ferromagnetic material in terms of improving crystal orientation of the second magnetic layer 29. In this case, compositions of the respective layers may be the same, or elements included in the respective layers may be different from each other, or composition ratios in the respective layers may be different from each other.

The RuB alloy layer 28 is made of RuB or RuB—X3, where X3 is at least any one of Co, Re, Rh, Cu, Ag, Ta, Hf, Gd, Pt, Pd and Mn. The RuB alloy layer 28 has an hcp structure, and grows epitaxially on the first magnetic layer 27. That is, a grain boundary segregation structure is produced in which crystal grains of the RuB alloy layer 28 grow on a surface of crystal grains of the first magnetic layer 27, and grain boundary parts of the RuB alloy layer 28 are produced on a surface of grain boundary parts of the first magnetic layer 27. It is inferred that the grain boundary parts of the RuB alloy layer 28 are produced as a result of B segregating as a result of B being added to Ru, and are made approximately only of B. On the other hand, it is inferred that crystal grains of the RuB alloy layer 28 have a structure near to single crystals only from Ru or slightly including B. Thus, the RuB alloy layer 28 inherits the grain boundary segregation structure of the first magnetic layer 27, and then produces a satisfactory grain boundary segregation structure in the second magnetic layer 29 on the RuB alloy layer 28.

When the RuB alloy layer 28 is made of RuB, B concentration may be preferably set within a range between 0.1 and 10 atomic % (further preferably, in a range between 2 and 10 atomic %). When the B concentration exceeds 10 atomic %, crystal orientation in the second magnetic layer 29 comes to easily degrade, and saturation magnetization and so forth of the second magnetic layer 29 comes to easily degrade.

When the RuB alloy layer 28 is made of material in which any one of Co, Re and Rh is added to RuB, since Co, Re or Rh is dissolved with Ru by the whole amount, crystal grains of the RuB alloy layer 28 can be changed to be non-magnetic while degradation in crystallinity of Ru crystal structure is avoided.

Further, it is preferable to make the RuB alloy layer 28 of material in which any one of Cu, Ag, Ta and Hf is added to RuB, since Cu, Ag, Ta or Hf accelerates segregation of B in a grain boundary. Thereby, a further satisfactory grain boundary segregation structure is produced in the RuB alloy layer 28. Furthermore, any one of Gd, Pt, Pd and Mn may be added to RuB in the RuB alloy layer 28.

A thickness of the RuB alloy layer 28 is set within a range between 0.4 and 1.2 nm. As a result of the thickness of the RuB alloy layer 28 being set in this range, the first magnetic layer 27 and the second magnetic layer 29 are coupled via the RuB alloy layer 28 antiferromagnetically in a manner of exchange coupling.

The second magnetic layer 29 is made of CoCrPt or CoCrPt—M2 alloy, where M2 is at least any one selected from B, Cu, Ag, Nb, Ru, Ni, V, Ta, Au, Fe, Mn, Ir, Si, Pd and Re. Specifically, the second magnetic layer 29 is made of CoCrPt, CoCrPtB, CoCrPtTaB, CoCrPtBCu or such.

The second magnetic layer 29 has a grain boundary segregation structure having crystal grains having an hcp structure and grain boundary parts in which Cr or such segregates. The crystal grains of the second magnetic layer 29 epitaxially grows on surfaces of crystal grains of the RuB alloy layer 28. Since a lattice constant, approximately 0.25 nm, of a-axis of crystal grains including CoCrPt of the second magnetic layer 29 is close to a lattice constant, 0.27 nm, of a-axis of Ru of the RuB alloy layer 28, lattice matching is satisfactory. Further, since the grain boundary segregation structure is produced in the RuB alloy layer 28, the second magnetic layer 29 is easy to segregate. Accordingly, a satisfactory grain boundary segregation structure is produced in the second magnetic layer 29 on the RuB alloy layer 28 in a stage of a growth beginning, and crystallinity and crystal orientation of the crystal grains improve. As a result, even when the second magnetic layer 29 is reduced in its thickness, degradation in magnetostatic characteristics such as a coercive force sequareness ratio and so forth can be inhibited, and degradation in S/Nm can be inhibited.

Further, in the second magnetic layer 29, SiO₂ may be added to CoCrPt or CoCrPt—M2. In such a composition, a so-called granular structure is obtained in which CoCrPt or CoCrPt—M2 forms crystal grains, and SiO₂ forms grain boundary parts. Also in this case, since the crystal grains of the second magnetic layer 29 are produced on crystal grains of the RuB alloy layer 28, a satisfactory grain boundary segregation structure is produced even from a stage of a growth beginning, and crystallinity and crystal orientation of the crystal grains improve.

The ferromagnetic material composing the second magnetic layer 29 may be different from ferromagnetic material composing the first magnetic layer 27. For example, the ferromagnetic material composing the second magnetic layer 29 is selected from materials having a larger anisotropic magnetic field than that of the ferromagnetic material composing the first magnetic layer 27. For such a method of selecting ferromagnetic material, ferromagnetic material not including Pt may be selected for the first magnetic layer 27, while ferromagnetic material including Pt may be selected for the second magnetic layer 29. As another method, ferromagnetic material having higher Pt concentration (as atomic concentration) may be applied for the second magnetic layer 29 than that of the first magnetic layer 27.

Further, the second magnetic layer 29 may be a laminate of a plurality of layers. In this case, compositions of the respective layers may be the same, or elements included in the respective layers may be different from each other, or composition ratios in the respective layers may be different from each other. As examples of such a configuration of the second magnetic layer 29, from the side of the RuB alloy layer 28, CoCrPtBCu/CoCrPtB are laminated, and CoCrPtBCu is provided as a composition for low medium noise while CuCrPtB is provided as a composition for high output.

A thickness of the second magnetic layer 29 is set in a range between 5 and 25 nm. Further, the thickness of the second magnetic layer 29 may be preferably set from a relationship between a thickness and residual magnetization of the second magnetic layer 29 and a thickness and residual magnetization of the first magnetic layer 27, as shown below. The relationship is t1×Br1<t2×Br2. Br1 and Br2 denote respective residual magnetizations of the first magnetic layer 27 and the second magnetic layer 29. t1 and t2 denote respective thickness of the first magnetic layer 27 and the second magnetic layer 29. By making a setting according to this relationship, the recording layer 26 substantially has a residual magnetization film thickness product of t2×Br2−t1×Br1. The residual magnetization film thickens product (=Br2×t2−Br1×t1) may be preferably in a range between 1.5 and 10.0 nTm.

As described above, in the recording layer 26, the first mantic layer 27 and the second magnetic layer 29 laminated with the RuB alloy layer 28 inserted therebetween are coupled antiferromagnetically in an exchange coupling manner. Accordingly, a substantial volume of 1 bit produced by recording is a sum of the first magnetic layer 27 and the second magnetic layer 29 coupled in an exchange coupling manner. Thus, a substantial volume substantially increases in comparison to a case where a recording layer includes only a single second magnetic layer 29. As a result of the substantial volume V increasing, KuV/kT, which is an index of resistance to thermal fluctuation increases, and resistance to thermal fluctuation, improves.

The recording layer 26 is not limited to the two layers of the first magnetic layer 27 and the second magnetic layer 29, and, may be made of a laminate of more than two magnetic layers. The magnetic layers should be coupled mutually in an exchange coupling manner, and at least two thereof should be coupled antiferromagnetically.

The protective layer 30 is set in a range between 0.5 and 10 nm (preferably, in a range between 0.5 and 5 nm) in its thickness, and, is made of, for example, diamond-like carbon, carbon nitride, amorphous carbon or such.

The lubrication layer 31 is made of, for example, organic liquid lubricant made of perfluoropolyether as a main chain and —OH, phenyl radical or such, as a terminal group. It is noted that, according to a particular type of the protective layer 30, it is determined whether or not the lubrication layer 31 should be actually provided.

A method for producing each layer of the above-described magnetic recording medium 20 is, except the lubrication layer 31, a vacuum process such as a spattering method, a vacuum deposition method, a CVD (chemical vapor deposition) method, or such, or a wet process such as an electroplating method, an elecroless plating method or such. The lubrication layer 30 is produced by means of a dip method such as a lifting method, a liquid surface lowering method or such, a coating method such as a spin coat method, or such.

Thus, the RuB alloy layer 28 is provided between the first magnetic layer 27 and the second magnetic layer 29 of the recording layer 26 in the magnetic recording medium 20 in the first example. The RuB alloy layer 28 epitaxially grows on the first magnetic layer 27, and further the second magnetic layer 29 epitaxially grows on the RuB alloy layer 28. In the RuB alloy layer 28, the grain boundary segregation structure is produced by B in the film, which inherits the grain boundary segregation structure of the first magnetic layer 27, which is further inherited by the second magnetic layer 29. Accordingly, crystallinity and crystal orientation in an initially growing region of the second magnetic layer 29 has a satisfactory quality. As a result, degradation in magnetostatic characteristics can be inhibited even when the second magnetic layer 29 is reduced in its thickness, and degradation in signal-to-medium-noise ratio can be inhibited. Accordingly, it is expected that a total S/N of a magnetic storage (simply referred to as ‘S/N’ hereinafter) can be improved.

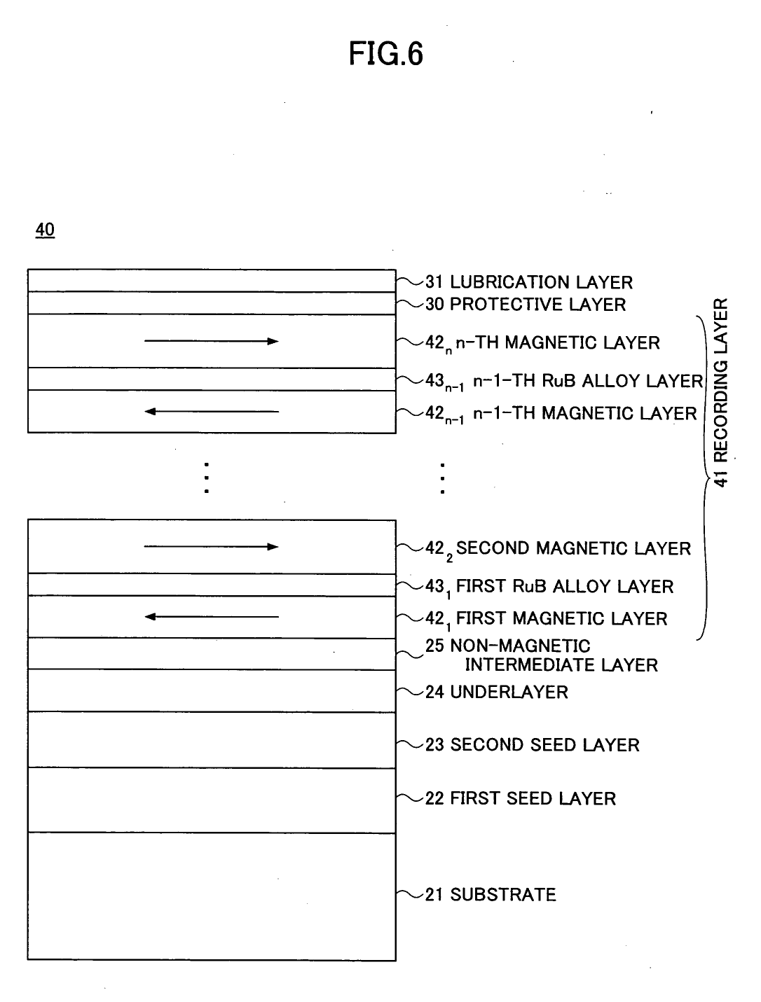

FIG. 6 shows a sectional view of a magnetic recording medium in a second example of the first carrying-out mode. The magnetic recording medium in the second example is a variant of the magnetic recording medium in the first example described above. In FIG. 6, parts corresponding to those already described above are given with the same reference numerals, and description thereof is omitted.

As shown in FIG. 6, the magnetic recording medium 40 in the second example has a configuration in which a substrate 21, and, thereon, a first seed layer 22, a second seed layer 23, an underlayer 24, a non-magnetic intermediate layer 25, a recording layer 41, a protective layer 30 and a lubrication layer 31 are laminated. The recording layer 41 has a configuration in which, from the non-magnetic intermediate layer 25, a first magnetic layer 42₁, a first RuB alloy layer 43₁, a second magnetic layer 42₂, a second RuB alloy layer 43₂, . . . , an n−1-th magnetic layer 42ₙ₋₁, an n−1-th RuB alloy layer 43ₙ₋₁ and an n-th magnetic layer 42ₙ are laminated. The magnetic recording medium 40 is configured the same as the magnetic recording medium 20 in the first example except that the recording layer 41 Is different. ‘n’ denotes a natural number more than 2.

The recording layer 41 is made of n magnetic layers 42₁ through 41ₙ, and the RuB alloy layers 43₁ through 43ₙ₋₁ produced between the respective magnetic layers 42₁ through 42ₙ. The n magnetic layers 42₁ through 42ₙ are made of material selected from the same materials as those of the first magnetic layer 27 and the second magnetic layer 29 in the first example shown in FIG. 5. However, the first magnetic layer 42₁ may preferably be selected from the same materials as those of the first magnetic layer 27 in the first example shown in FIG. 5, and the n-th magnetic layer 42ₙ may preferably be selected from the same materials as those of the second magnetic layer 29 in the first example shown in FIG. 5. Further, each of thicknesses of the respective magnetic layers 42₁ through 42ₙ may be preferably set in a range between 1 and 20 nm.

The RuB alloy layers 43₁ through 43ₙ₋₁ are made of material selected from the materials same as those of the RuB alloy layer 28 in the first example shown in FIG. 5, and each has a thickness in the range the same as that of the RuB alloy layer 28 in the first example of FIG. 5. Thereby, the magnetic layers, both sides of each RuB alloy layer 43₁ through 43ₙ₋₁, can be coupled antiferromagnetically in an exchange coupling manner.

In the recording layer 41, any one or any ones of the n−1 RuB alloy layers 431 through 43ₙ₋₁ may be omitted. The magnetic layers above and below the thus-omitted RuB alloy layer couple mutually ferromagnetically in an exchange coupling manner, and directions of magnetization thereof become parallel. Also in such a configuration, a configuration should be provided such that a residual magnetization film thickness product of the entire recording layer 41 may fall within a predetermined range.

In the magnetic recording medium 40 in the second example, the recording layer 41 has the n magnetic layers 42₁ through 42ₙ, the RuB alloy layer 43₁ through 43ₙ₋₁ produced between the respective magnetic layers 41₁ through 41ₙ epitaxially grow on the magnetic layers therebelow, respectively, and further, the magnetic layers thereabove grow on the RuB alloy layers 43₁ through 43ₙ₋₁, respectively. In the RuB alloy layers 43₁ through 43ₙ, grain boundary segregation structures are produced by B in the films, and therewith, grain boundary segregation structures of the lower magnetic layers are inherited by the upper magnetic layers therewith, respectively. Accordingly, crystallinity and crystal orientation in the upper magnetic layers have satisfactory qualities in initially growing regions, respectively. As a result, crystallinity and crystal orientation in each magnetic layer has a satisfactory quality even when the many magnetic layers 42₁ through 42ₙ are produced. Accordingly, degradation in magnetostatic characteristics can be inhibited even when the n-th magnetic layers 42ₙ is reduced in its thickness, and degradation in signal-to-medium-noise ratio can be inhibited. Accordingly, it is expected that an S/N of a magnetic storage provided with the magnetic recording medium 40 in the second example can be improved. Further, since the many magnetic layers 42₁ through 42ₙ are coupled antiferromagnetically in an exchange coupling manner in the magnetic recording medium 40 in the second example, characteristics of resistance to thermal fluctuation can be improved in comparison to the magnetic recording medium 20 in the first example. Further, since each of respective thicknesses of the magnetic layers 42₁ through 42ₙ can be reduced, enlargement of crystal grains can be inhibited, and are miniaturized, so that reduction in medium noise can also be achieved simultaneously.

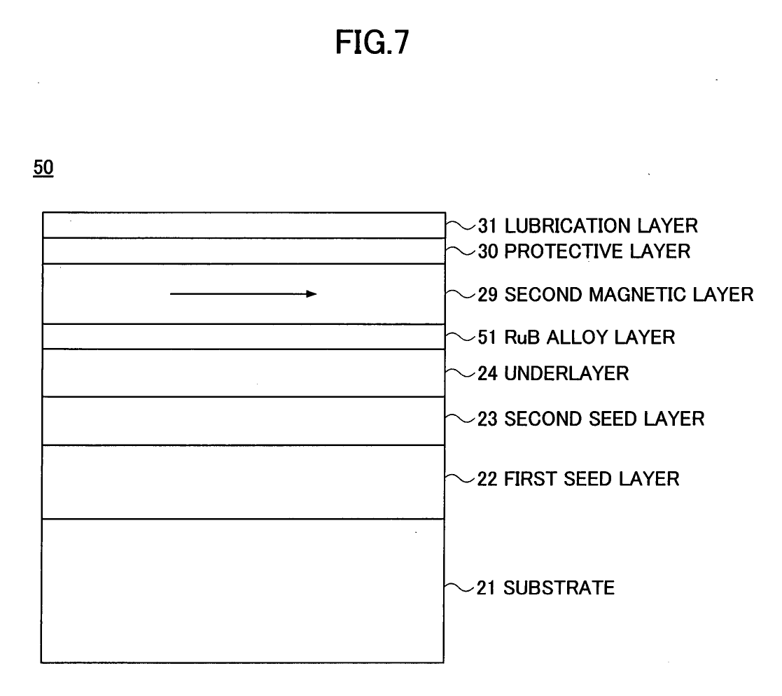

FIG. 7 shows a sectional view of a magnetic recording medium in a third example of the first carrying-out mode. The magnetic recording medium in the third example is a variant of the magnetic recording medium in the first example. In FIG. 7, parts corresponding to those already described above are given with the same reference numerals and description is omitted.

As shown in FIG. 7. the magnetic recording medium 50 in the third example has a configuration in which a substrate 21, and, thereon, a first seed layer 22, a second seed layer 23, an underlayer 24, a RuB alloy layer 51, a second magnetic layer 29, a protective layer 30 and a lubrication layer 31 are laminated. The magnetic recording medium 50 has the RuB alloy layer 51 produced on the underlayer 24, and a recording layer only includes the second magnetic layer 29. Other than these matters, the third example is configured the same as the magnetic recording layer in the first example.

The second magnetic layer 29 is made of material selected from the same materials as those of the second magnetic layer 29 shown in FIG. 5. The second magnetic layer 29 may be made not only of the single layer but also of a laminate of a plurality of layers. Compositions of the respective layers may be the same, or elements included in the respective layers may be different from each other, or composition ratios in the respective layers may be different from each other.

The RuB alloy layer 51 is made of material selected from the same materials as those of the RuB alloy layer 28 shown in FIG. 5. The RuB alloy layer 51 is produced on Cr or Cr—X1 alloy having a bcc crystal structure. The RuB alloy layer 51 has a grain boundary segregation structure produced in a self-producing manner and, in crystal grains of the RuB alloy layer 51, c-axis is oriented in a direction along a film surface due to an influence of the underlayer 24. The grain boundary segregation structure of the RuB alloy layer 51 accelerates production of a grain boundary segregation structure in the second magnetic layer 29.

A thickness of the RuB alloy layer 51 is set in a range between 0.2 and 3 nm. This is because, when the thickness of the RuB alloy layer 51 exceeds 3 nm, saturation magnetization of the second magnetic layer 29 tends to fall around an upper limit of a range between 0.1 and 10 atomic % in B concentration.

In the magnetic recording medium 50 in the third example, the RuB alloy layer 51 has the grain boundary segregation structure produced in a self-producing manner, and accelerates production of the grain boundary segregation structure in the second magnetic layer 29. Thereby, the grain boundary segregation structure in the second magnetic layer at a growth beginning becomes satisfactory. Thereby, even when the second magnetic layer 29 is reduced in its thickness, degradation in magnetostatic characteristics can be inhibited, and degradation in signal-to-medium-noise can be inhibited. Accordingly, improvement of S/N of a magnetic storage provided with the magnetic recording medium 50 in the third example is expected.

Although not shown, the non-magnetic intermediate layer 25 shown in FIG. 5 may be produced between the underlayer 24 and the RuB alloy layer 51 also in the magnetic recording medium 50 in the third example. Thereby, the RuB alloy layer 51 epitaxially grows on a surface of the non-magnetic intermediate layer 24 having an hcp structure. Further, including B in the non-magnetic intermediate layer 25 is advantageous in terms of accelerating segregation of B in the RuB alloy layer 51. The RuB alloy layer 51 inherits a grain boundary segregation structure of the non-magnetic intermediate layer 25, and accelerates production of the grain boundary segregation structure in the second magnetic layer 29. Accordingly, even when the second magnetic layer 29 is reduced in its thickness, degradation in magnetostatic characteristics can be inhibited, and degradation in signal-to-medium-noise can be inhibited. Accordingly, improvement of S/N of a magnetic storage provided with such a magnetic recording medium is expected.

Next, embodiments 1 and 2 according to the present carrying-out mode and comparison examples not according to the present invention are described.

An embodiment 1 is described now.

A magnetic disk according to the embodiment 1 has the same configuration as that of the magnetic recording medium in the first example shown in FIG. 5. A specific configuration thereof is shown below:
Glass substrate: (diameter: 65 mm);
First seed layer: Cr₅₀Ti₅₀ film (25 nm);
Second seed layer: Al₅₀Ru₅₀ film (50 nm);
Underlayer: Cr₇₅Mo₂₅ film (5 nm);
Non-magnetic intermediate layer: Co₅₈Cr₄₂ film (5 nm);
Recording layer:
   First magnetic layer: C0₇₈Cr₁₈B₄ film (2 nm)
   RuB alloy layer: Ru₉₅B₅ film (1.0 nm);
   Second magnetic layer: CO₆₀Cr₁₈Pt₁₁B₈Cu₃ film;
Protective layer: DLC (diamond-like carbon) film (4 nm); and
Lubrication layer; organic liquid lubricant (1.5 nm).

It is noted that parenthetic numerals denote respective thicknesses. Magnetic disks having different thicknesses of the second magnetic layer from 3 nm through 15 nm were produced.

The magnetic disk in the embodiment 1 was produced as follows: First, on a surface of a glass substrate, a texture extending along a circumferential direction was produced. Then, the glass substrate, a surface of which was cleaned, was heated for 190° C. in vacuo.

Next, a DC magnetron spatter apparatus was applied, and the Cr₅₀Ti₅₀ film through the DLC film from among the above-mentioned film configuration were produced successively in Ar gas atmosphere (pressure: 0.67 Pa). Next, in a dip method, the lubrication layer was coated on a surface of the DLC film. It is noted that, the above-mentioned pressure was set by such a manner that argon gas was provided after high vacuum of not more than 1×10⁻⁵ Pa was created by evacuation in a heating apparatus and a vacuum chamber of the DCC magnetron spatter apparatus previously.

A comparison example 1 is described next.

A magnetic disk in the comparison example 1 had the same configuration as that of the embodiment 1 except that, instead of the Ru₉₅B₅ film, a Ru film (0.7 nm) was applied, and the comparison example 1 was produced in the same conditions as those of the embodiment 1.

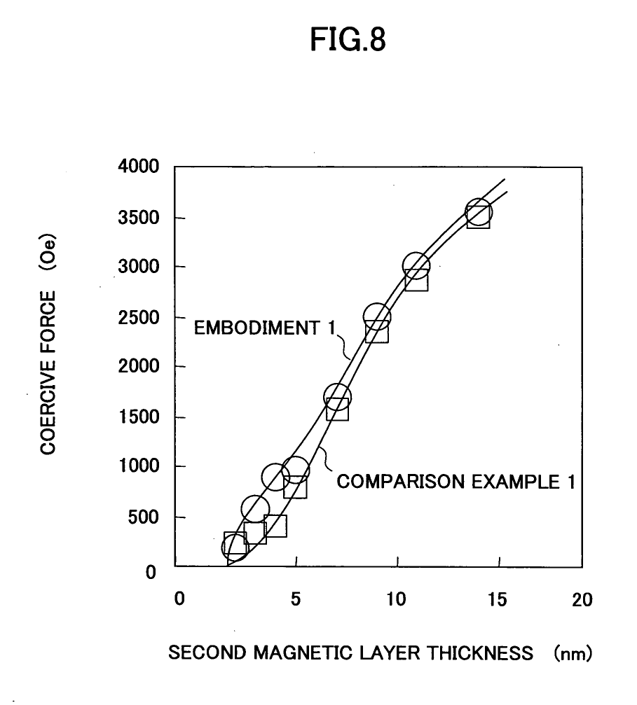

FIG. 8 through 12 show magnetostatic characteristics and magneto-electric transform characteristics of the magnetic disks in the embodiment 1 and the comparison example 1. In each of FIGS. 8 through 12, the embodiment 1 is represented by ‘◯’ while the comparison example is represented by ‘□’.

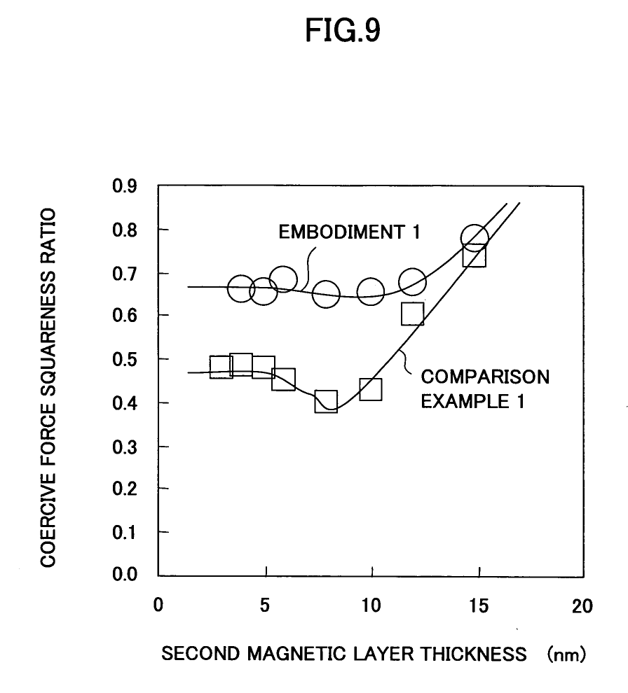

FIGS. 8 and 9 show relationship between magnetostatic characteristics and a thickness of the second magnetic layer of the magnetic disks in the embodiment 1 and the comparison example 1. An ordinate of FIG. 8 represents coercive force measured by a vibration sample magnetometer (VSM), and an ordinate of FIG. 9 represents a coercive force sequareness ratio measured by the VSM. A magnetic field applied by the VSM had a circumferential direction parallel to the substrate.

As shown in FIG. 8, coercive force of the embodiment 1 is higher than that of the comparison example 1 by the order of 200 Oe on a thinner side not more than 12 nm in the thickness of the second magnetic layer. As shown in FIG. 9, a coercive force sequareness ratio of the embodiment 1 is higher than that of the comparison example 1 in a thinner side not more than 15 nm, and, especially, very high at a not more than 10 nm. Further, a coercive force sequareness ratio is on the order of 0.67 even around 5 nm of the thickness of the second magnetic layer. Higher values in the coercive force and the coercive force sequareness ratio means that crystallinity in the second magnetic layer is. satisfactory and also, crystal orientation is satisfactory. Therefrom, it is seen that crystal orientation in an initially growing region of the second magnetic layer in the embodiment 1 according to the first carrying-out mode is satisfactory.

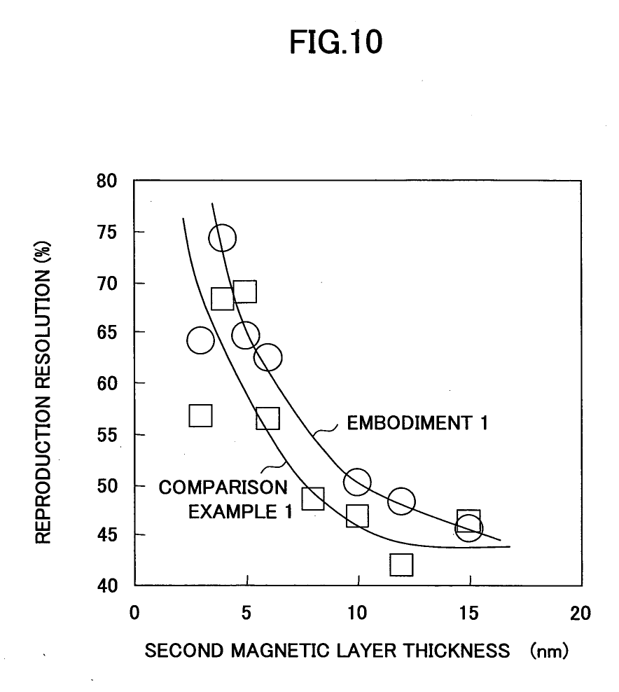

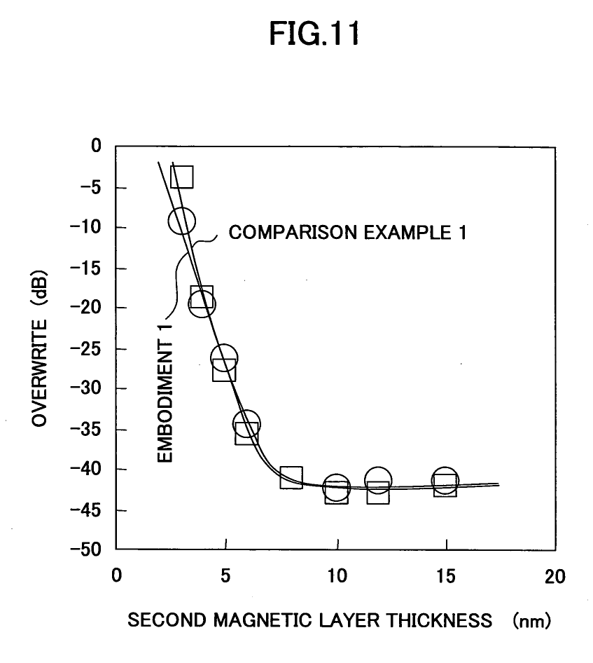

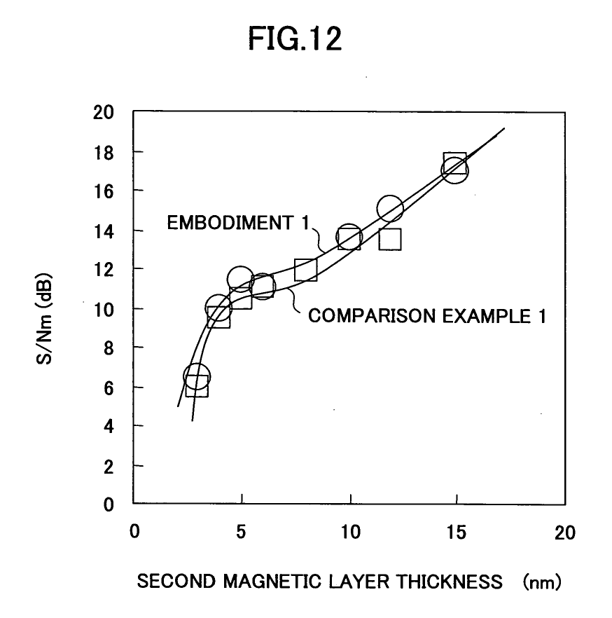

FIGS. 10 through 12 show relationship between magneto-electric transform characteristics and the thickness of the second magnetic layer in the magnetic disks in the embodiment 1 and the comparison example 1. An ordinate of FIG. 10 represents reproduction resolution, an ordinate of FIG. 11 represents overwrite and an ordinate of FIG. 12 represents S/Nm.

With reference to FIG. 10, reproduction resolution in each of the embodiment 1 and the comparison example 1 sharply increases as the thickness of the second mantic layer is reduced. The reduction resolution of the embodiment 1 is higher than that of the comparison example 1 by the order of 5% on a thinner side not more than 12 nm in the thickness of the second magnetic layer. Therefrom, it is expected that the embodiment 1 provides superior S/N by improving the reproduction resolution in comparison with the comparison example 1.

With reference to FIG. 11, values of the overwrite of the embodiment 1 and the comparison example 1 are approximately equal. Therefrom, in consideration together of the fact that coercive force of the embodiment 1 is higher than that of the comparison example 1 shown in FIG. 8 mentioned above, the embodiment 1 has crystal orientation presumably more satisfactory than that of the comparison example 1. The fact that overwrite of the embodiment 1 is equivalent to that of the comparison example 1 although the coercive force of the embodiment 1 is higher than that of the comparison example 1 shows that the embodiment 1 provides satisfactory recording easiness, and thus. the embodiment 1 is advantageous.

With reference to FIG. 12, it is seen that S/Nm of the embodiment 1 is better than that of the comparison example 1 by 0.5 dB on a thinner side of not more than 12 nm in the thickness of the second magnetic layer. Therefrom, it is seen that degradation in S/Nm otherwise occurring due to reduction in the thickness of the second magnetic layer is inhibited. ‘S’ of ‘S/Nm’ means solitary average output, and ‘Nm’ means medium noise.

In the embodiment 1, Ru₉₅B₅ is produced between the first magnetic layer and the second magnetic layer, thereby reduction in coercive force sequareness ratio otherwise occurring due to reduction in the thickness of the second magnetic layer is inhibited, degradation in S/Nm is inhibited, and on the other hand, reproduction resolution improves. Therefrom, it is expected that the embodiment 1 provides more superior S/N than that of the comparison example 1.

It is noted that, measurement of reproduction resolution, overwrite and S/Nm was carried out with the use of a commercially available spin stand and a complex magnetic head including an induction type recording device and a GMR reproduction device. Reproduction resolution is obtained from: (average output at a linear recording density of 357 kFCI)/(average output at a linear recording density of 89 kFCI)×100 (%). Overwrite is an erase ratio of a signal of a linear recording density of 714 kFCI obtained when a signal of a linear recording density of 119 kFCI was overwritten on the signal of the linear recording density of 714 kFCI. S/Nm was obtained as 10×log(Siso/Nm)(dB) from an average output Siso (linear recording density of 10 kFCI) and a medium noise Nm.

The embodiment 2 is described next.

A magnetic disk according to the embodiment 2 has the same configuration as that of the magnetic recording medium in the first example shown in FIG. 5. A specific configuration thereof is shown below:
Glass substrate: (diameter: 65 mm);
First seed layer: Cr₅₀Ti₅₀ film (20 nm);
Second seed layer: A1₅₀Ru₅₀ film (7 nm);
Underlayer: Cr film (2 nm)/Cr₇₅Mo₂₅ film (4 nm);
Non-magnetic intermediate layer: Co₅₀Cr₂₂Ru₂₅B₃ film (3 nm);
Recording layer:
   First magnetic layer: Co₈₄Cr₁₄B₂ film (2.5 nm);
   RuB alloy layer: Ru₉₅B₅ film (0.9 nm);
   Second magnetic layer: laminate of CoCrPtBCu film (lower layer) and CoCrPtB film (upper layer); Protective layer: DLC (diamond-like carbon) film (4 nm); and
Lubrication layer; organic liquid lubricant (1.5 nm).

It is noted that parenthetic numerals denote respective thicknesses. Magnetic disks were produced in which CoCrPtBCu film (lower layer) and the CoCrPtB film (upper layer) in the second magnetic layer have a fixed ratio 7:3 therebetween, while the thickness of the second magnetic layer was changed approximately in a range between 5 and 25 nm. The magnetic disk according to the embodiment 2 was produced approximately in the same manner as that of the embodiment 1. A texture on the glass substrate was produced also the same as the embodiment 1.

A comparison example 2 is described next.

A magnetic disk in the comparison example 2 had the same configuration as that of the embodiment 2 except that, the non-magnetic intermediate layer was omitted, a Co₈₄Crl₆ film (2.6 nm) was applied as a first magnetic layer, and a Ru film (0.8 nm) was applied instead of the Ru₉₅B₅ film, and the comparison example 2 was produced in the same conditions as those of the embodiment 2.

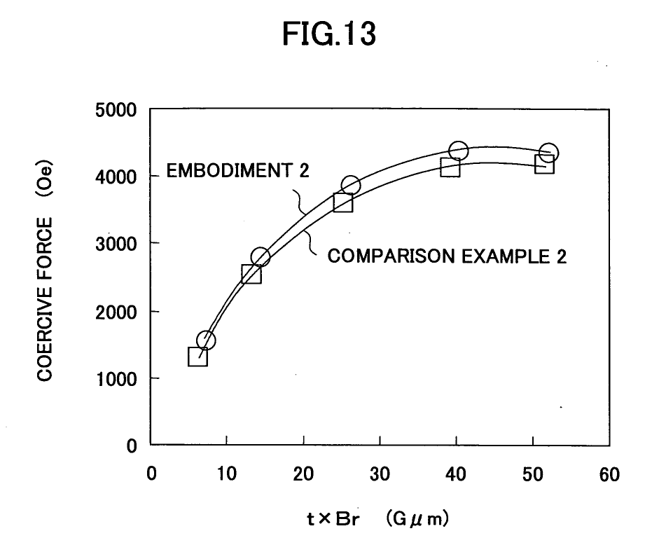

FIG. 13 through 18 show magnetostatic characteristics, magneto-electric transform characteristics and thermal fluctuation characteristics of the magnetic disks in the embodiment 2 and the comparison example 2. In each of FIGS. 13 through 18, the embodiment 2 is represented by ‘◯’ while the comparison example 2 is represented by ‘□’.

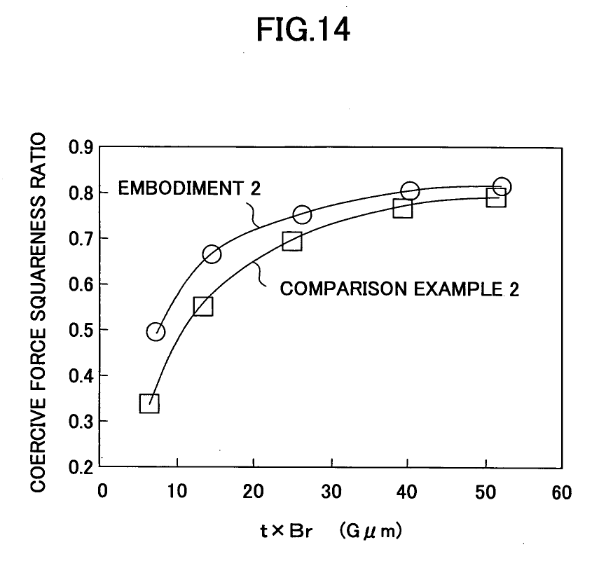

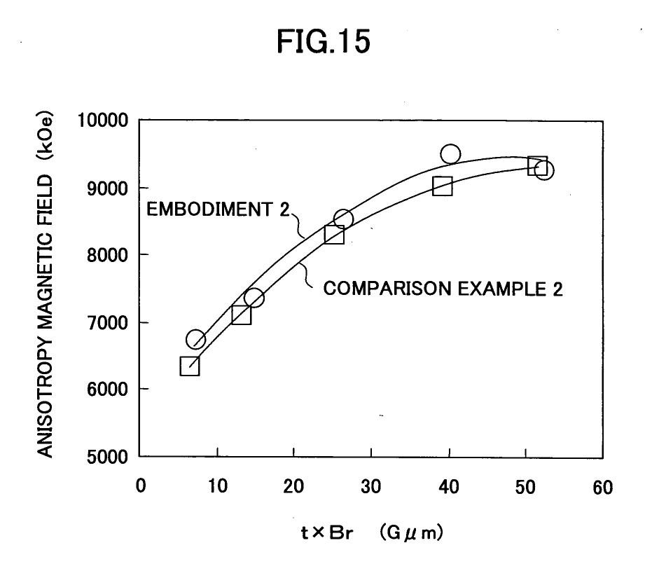

FIGS. 13 through 15 show relationship between magnetostatic characteristics and t×Br (residual magnetic flux film thickness product) of the second magnetic layer in the magnetic disks in the embodiment 2 and the comparison example 2. Ordinates of FIGS. 13 through 15 represent coercive force measured by a VSM in FIG. 13; a coercive force sequareness ratio measured by a Kerr effect measurement device in FIG. 14; and an anisotropy magnetic field measured by a magnetic torque gauge in FIG. 15. A magnetic field applied in the VSM and the Kerr effect measurement device was applied in parallel to a substrate surface of the magnetic disk also in a circumferential direction. A magnetic field applied in the magnetic toque gauge was applied in parallel to the substrate surface of the magnetic disk.

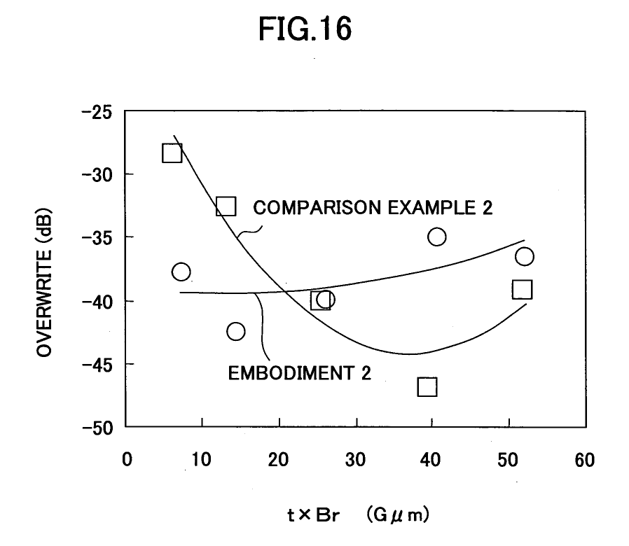

Abscissas of FIGS. 13 through 15 represent t×Br, and t×Br was obtained from conversion from a reproduction output. t×Br in abscissas in FIGS. 16 through 18 was obtained the same. As the reproduction output, an average output at a recording density of 89 kFCI was applied. In t×Br, ‘t’ denotes a thickness of the second magnetic layer, and ‘Br’ denotes a residual magnetic flux density along a direction in a film surface of the second magnetic layer also in a circumferential direction.

With reference to FIGS. 13 through 15, the embodiment 2 shows higher values in coercive force, a coercive force sequareness ratio and an anisotropy magnetic field than those of the comparison example 2. Especially, on a thinner film side of not more than 30 Gμm in t×Br, the embodiment 2 shows higher values than those of the comparison example 2 in each of these characteristic items. Therefrom, it is seen that degradation in magnetostatic characteristics is inhibited in the embodiment 2 more than in the comparison example 2, when the thickness of the second magnetic layer is reduced.

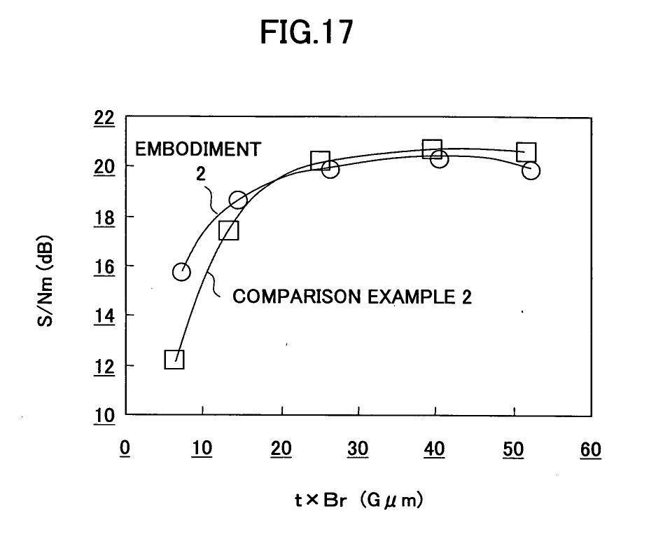

FIGS. 16 and 17 show relationship between magneto-electric transform characteristics and t×Br of the second magnetic layer in the embodiment 2 and the comparison example 2. An ordinate of FIG. 16 represents overwrite and an ordinate of FIG. 17 represents S/Nm.

With reference to FIG. 16, overwrite of the embodiment 2 is better than that of the comparison example 2 on a thinner film side of not more than approximately 25 Gμm in t×Br of the second magnetic layer. Further, with reference to FIG. 17, S/Nm of the embodiment 2 is better than that of the comparison example 2 on a thinner film side of not more than approximately 25 Gμm in t×Br of the second magnetic layer. Accordingly, it is seen, from overwrite and S/Nm, that the embodiment 2 is advantageous than the comparison example 2 on the thinner film side of not more than approximately 25 Gμm.

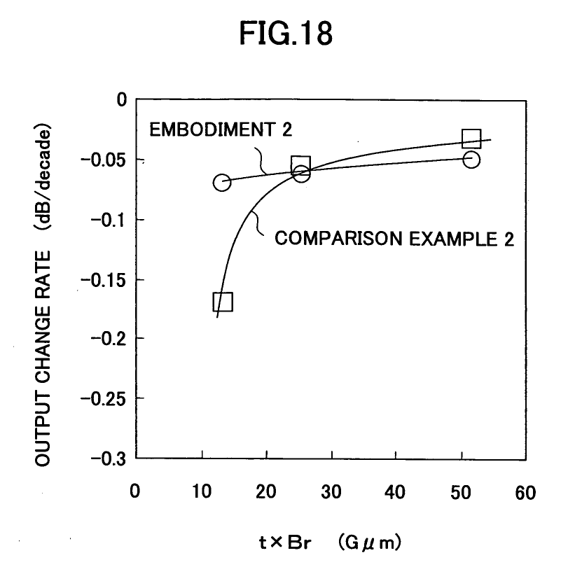

FIG. 18 shows relationship between characteristics of resistance to thermal fluctuation and t×Br of the second magnetic layer in the magnetic disks in the embodiment 2 and the comparison example 2. The characteristics of resistance to thermal fluctuation is expressed by an output change ratio (dB/decade). The output change ratio was obtained in such a manner that, a signal of a recording density of 357 kFCI was recorded on the magnetic disk, the signal was reproduced with the use of a magnetic head, and the output changed ratio was obtained from a temporal attenuation amount of the reproduction output.

With reference to FIG. 18, the output change ratio in the embodiment 2 is much reduced on a thinner film side of not more than approximately 25 Gμm in t×Br of the second magnetic layer in comparison to that of the comparison example 2. Such a reduced output change ratio means that characteristics of resistance to thermal fluctuation is satisfactory. Accordingly, it is seen that, in the embodiment 2, degradation in characteristics of resistance to thermal fluctuation is inhibited more than that of the comparison example 2, on a thinner film side of not more than approximately 25 Gμm in t×Br of the second magnetic layer. Therefrom, it is seen that the embodiment 2 is more suitable than the comparison example 2 for recording at a high recording density.

According to the embodiment 2, by producing the Ru₉₅B₅ film between the first magnetic layer and the second magnetic layer, degradation in magnetostatic characteristics and magneto-electric transform characteristics due to reduction in the film thickness of the second magnetic layer is inhibited more than in the comparison example 2 in which the Ru film is provided there. Therefrom, it is expected that the embodiment 2 may provide a superior S/N than that of the comparison example 2.

Further, in the embodiment 2, degradation in characteristics of resistance to thermal fluctuation due to reduction in the film thickness of the second magnetic layer is inhibited more than that of the comparison example 2. This means that the embodiment 2 is advantageous in recording at a high recording density more than in the comparison example 2.

A second carrying-out mode of the present invention is described next.

The second carrying-out mode relates to a magnetic storage provided with the magnetic recording medium in the first carrying-out mode described above.

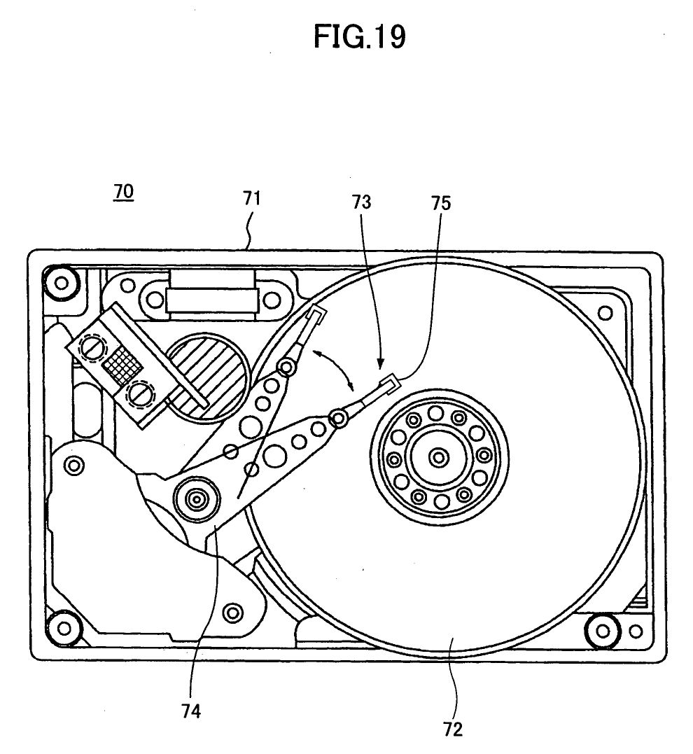

FIG. 19 shows relevant parts of the magnetic storage in the second carrying-out mode according to the present invention. As shown, the magnetic storage 70 has a housing 71. In the housing 71, a magnetic recording medium 72 driven and rotated by a spindle (not shown); a magnetic head 73; an actuator unit 74 supporting the magnetic head and rotating it in a radial direction of the magnetic recording medium, and so forth are provided. The magnetic head 73 is provided with, on its head slider 75, a reproduction device such as an MR device (magneto-resistance effect device), a GMR device (giant magneto-resistance effect device), a TMR device (tunnel magneto-resistance effect device) or such, and an inductive type recording device. A basic configuration itself of this magnetic storage is well-known, and details thereof are omitted.

The magnetic recording medium 72 is the magnetic recording medium in any one of the first through third examples of the first carrying-out mode described above. In the magnetic recording medium 72, degradation in a coercive force sequareness ratio due to a reduction in a film thickness of a most-surface-side magnetic layer, e.g., the second magnetic layer of the first example of the first carrying-out mode is inhibited and, degradation in S/Nm is inhibited. Further, reproduction resolution of the magnetic recording medium 72 increases. Therefrom, the magnetic storage 70 improves a total S/N, and high density recording can be achieved thereby. Further, in the magnetic recording medium 72, degradation in characteristics of resistance to thermal fluctuation due to a reduction in a film thickness of the most-surface-side magnetic layer is inhibited, and thus, also from this point, high density recording can be achieved by the magnetic storage 70.

A basic configuration of the magnetic storage 70 according to the present carrying-out mode is not limited to that shown in FIG. 19, and the magnetic head 73 is not limited to the above-described configuration. Instead, a well-known magnetic head may be applied. The number of sheets of the magnetic recording medium 72 is not limited to one, and may be more than one. Further, when a plurality of magnetic recording media 72 are thus provided in the magnetic storage 70, at least one magnetic recording medium in any one of the first through third examples of the first carrying-out mode should be provided therein, and therewith, the above-mentioned advantages can be obtained.

Further, the present invention is not limited to the above-described embodiments, and variations and modifications may be made without departing from the basic concept of the present invention claimed below.

For example, for the above-mentioned carrying-out modes, examples in an in-surface system have been described in which, in the magnetic recording medium, a magnetization direction of the recording layer is parallel to the substrate surface. However, the present invention may also be applied to an oblique orientation magnetic recording medium in which, due to crystal orientation in an underlayer, a magnetization direction in a recording layer is oblique to the substrate surface.

Further, in the first through third examples of the first carrying-out mode and the second carrying-out mode, the magnetic recording media may be magnetic tapes. As the magnetic tape, a tape-shaped substrate is applied, and as the substrate material, a plastic film, e.g., polyethylene terephthalate, polyethylene naphthalate, polyimide, or such is applied.

The present application is based on Japanese priority application No. 2005-168899, filed on Jun. 8, 2005, the entire contents of which are hereby incorporated herein by reference.

What is claimed is:

1. A magnetic recording medium comprising:
a substrate;
an underlayer, produced on the substrate, comprising Cr or Cr alloy:
a first magnetic layer, produced on the underlayer, comprising CoCr or CoCr alloy;
an RuB alloy layer produced on the first magnetic layer; and
a second magnetic layer, produced on the RuB alloy layer, comprising CoCrPt or CoCrPt alloy, and coupled with the first magnetic layer in an antiferromagnetic exchange coupling manner, wherein:
said RuB alloy layer comprises RuB having an hcp structure or RuB alloy having the Rub as a chief ingredient, and also, epitaxially grows on a surface of the first magnetic layer; and
said second magnetic layer epitaxially grows on a surface of the RuB alloy layer.

2. The magnetic recording medium as clamed in claim 1, wherein:
setting is made for a thickness of said RuB alloy layer in a range between 0.4 nm and 1.2 nm.

3. The magnetic recording medium as claimed in claim 1, further comprising a non-magnetic intermediate layer between the underlayer and the first magnetic layer, wherein:
said non-magnetic intermediate layer has an hcp structure, and comprises any one of a group of Co—X2, CoCr, CoCrB, CoCr—X2 and CoCrB—X2; and said X2 comprises at least one of a group of Ta, Mo, Mn, Re, Ru and Hf.

4. The magnetic recording medium as claimed in claim 1, wherein:
said first magnetic layer comprises at least any one of a group of CoCr, CoCrB, CoCr—M1 alloy and CoCrB—M1 alloy; and said M1 comprises at least any one of a group of Pt, Ta, Ni, Cu, Ag, Fe, Nb, Au, Mn, Ir, Si and Pd.

5. The magnetic recording medium as claimed in claim 1, wherein:
said magnetic recording medium is provided with a laminate between the RuB alloy layer and the second magnetic layer, said laminate comprises, from the side of the RuB alloy layer, another magnetic layer and another RuB alloy layer laminated in the stated order;
said another magnetic layer comprises any one of group of CoCr, CoCrB, CrCr—M1 alloy and CoCrB—M1 alloy and said M1 comprises at least any one of a group of Pt, Ta, Ni, Cu, Ag, Fe, Nb, Au, Mn, Ir, Si and Pd; and
said another RuB layer comprises RuB having an hcp structure or RuB alloy having the RuB as a chief ingredient.

6. A magnetic recording medium comprising:
a substrate;
an underlayer, produced on the substrate, comprising Cr or Cr alloy:
an RuB alloy layer produced on the underlayer; and
a magnetic layer, produced on the RuB alloy layer, comprising CoCrPt or CoCrPt alloy, wherein:
said RuB alloy layer comprises RuB having an hcp structure or the RuB alloy having Rub as a chief ingredient; and
said magnetic layer epitaxially grows on a surface of the RuB alloy layer.

7. The magnetic recording medium as clamed in claim 6, wherein:
setting is made for a thickness of said RuB alloy layer in a range between 0.2 nm and 3 nm.

8. The magnetic recording medium as claimed in claim 6, further comprising an intermediate layer between the underlayer and the RuB alloy layer, said non-magnetic layer comprising non magnetic CoCr or CoCr alloy.

9. The magnetic recording medium as claimed in claim 1, wherein:
said RuB alloy layer comprises RuB, and setting is made for concentration of B in the RuB in a range between 0.1 atomic % and 10 atomic %.

10. The magnetic recording medium as claimed in claim 6, wherein:
said RuB alloy layer comprises RuB, and setting is made for concentration of B in the RuB in a range between 0.1 atomic % and 10 atomic %.

11. The magnetic recording medium as claimed in claim 1, wherein:
said RuB alloy layer comprises RuB—X3 having RuB as a chief ingredient, and said X3 comprises at least any one of a group of Co, Re, Rh, Cu, Ag, Ta, Hf, Gd, Pt, Pd and Mn.

12. The magnetic recording medium as claimed in claim 6, wherein:
said RuB alloy layer comprises RuB—X3 having RuB as a chief ingredient, and said X3 comprises at least any one of a group of Co, Re, Rh, Cu, Ag, Ta, Hf, Gd, Pt, Pd and Mn.

13. The magnetic recording medium as claimed in claim 1, wherein:
said second magnetic layer comprises CoCrPt or CoCrPt—M2 alloy, and said M2 comprises at least any one of a group of B, Cu, Ag, Nb, Ru, Ni, V, Ta, Au, Fe, Mn, Ir, Si, Pd and Re.

14. The magnetic recording medium as claimed in claim 6, wherein:
said magnetic layer comprises CoCrPt or CoCrPt—M2 alloy, and said M2 comprises at least any one of a group of B, Cu, Ag, Nb, Ru, Ni, V, Ta, Au, Fe, Mn, Ir, Si, Pd and Re.

15. The magnetic recording medium as claimed in claim 1, further comprising a first seed layer comprising amorphous non-magnetic metal material, between the substrate and the underlayer.

16. The magnetic recording medium as claimed in claim 6, further comprising a first seed layer comprising amorphous non-magnetic metal material, between the substrate and the underlayer.

17. The magnetic recording medium as claimed in claim 1, further comprising a second seed layer comprising crystalline non-magnetic metal material having a B2 structure, between the substrate and the underlayer.

18. The magnetic recording medium as claimed in claim 6, further comprising a second seed layer comprising crystalline non-magic metal material having a B2 structure, between the substrate and the underlayer.

19. The magnetic recording medium as claimed in claim 1, wherein:
on a surface of the substrate, a texture comprising depressions and projections long along a recording direction is formed.

20. The magnetic recording medium as claimed in claim 6, wherein:
on a surface of the substrate, a texture comprising depressions and projections long along a recording direction is formed.

21. A magnetic storage comprising:
the magnetic recording medium clamed in claim 1; and
a recording/reproduction unit comprising a recording device and a magneto-resistance effect type reproduction device.

22. A magnetic storage comprising:
the magnetic recording medium clamed in claim 6; and
a recording/reproduction unit comprising a recording device and a magneto-resistance effect type reproduction device.
